(19) United States
(12) Patent Application Publication
(10) Pub. No.: US 2017/0353064 A1
(43) Pub. Date: Dec. 7, 2017

(54) COOLING OF AN AXIAL END REGION OF A STATOR IN A ROTATING ELECTRICAL MACHINE

(71) Applicant: Siemens Aktiengesellschaft, Munich (DE)

(72) Inventors: Thorsten Krol, Duisburg (DE); Christoph Lehmann, Neukirchen-Vluyn (DE); Andrey Mashkin, Köln (DE)

(73) Assignee: Siemens Aktiengesellschaft, Munich (DE)

(21) Appl. No.: 15/524,318

(22) PCT Filed: Oct. 30, 2015
(86) PCT No.: PCT/EP2015/075295

§ 371 Date: May 4, 2017

(30) Foreign Application Priority Data
Nov. 18, 2014 (DE) 10 2014 223 527.8

(51) Int. Cl. H02K 1/20; H02K 9/16; H02K 9/06

(52) U.S. Cl. CPC H02K 1/20; H02K 9/06; H02K 9/16

(57) ABSTRACT

An arrangement for cooling at least one axial end region of a stator in a rotating electrical machine, having: at least one annular chamber which is disposed on the radially outer periphery of at least one portion of the axial end region having at least one radial cooling duct, and which on the radially inner part towards the axial end portion is at least partially open and is communicatingly connected to the radial cooling duct, and which is sealed with respect to the axial end region; and at least one low-pressure line which is communicatingly connected to the annular chamber, and via which the annular chamber is communicatingly connected to a low-pressure chamber in the rotating electrical machine which, relative to a flow of cooling fluid that is created by a shaft-mounted fan on a rotor in the rotating electric machine, is upstream of the shaft-mounted fan.

### CROSS REFERENCE TO RELATED APPLICATIONS

This application is the US National Stage of International Application No. PCT/EP2015/075295 filed Oct 30, 2015, and claims the benefit thereof. The International Application claims the benefit of German Application No. DE 102014223527.8 filed Nov 18, 2014. All of the applications are incorporated by reference herein in their entirety.

### FIELD OF INVENTION

The invention relates to an arrangement and a method for cooling at least one axial end region of a stator of a rotating electrical machine, in particular a generator.

The invention moreover relates to a rotating electrical machine, in particular a generator.

### BACKGROUND OF INVENTION

In response to the requirements for greater flexibility in the energy market, because they can be used flexibly, gas turbine-driven power plants are being operated more and more commonly in load-following mode. Here operation increases in an underexcited output range of the output graph of a generator of a power plant. This less active output range is limited, inter alia, by heating in axial end regions of a stator of the generator, which should not exceed a maximum threshold value.

### SUMMARY OF INVENTION

The object of the invention is to increase the usability of a rotating electrical machine and a power plant equipped therewith.

The arrangement according to the invention for cooling at least one axial end region of a stator of a rotating electrical machine, in particular a generator, comprises:—at least one annular chamber which can be arranged radially on the outer circumference of at least one portion, having at least one radially extending cooling duct, of the axial end region, and which is designed to be at least partially open radially inward in the direction of the axial end region and as a result can be connected in communicating fashion to the radial cooling duct, and which is sealed with respect to the axial end region; and—at least one low-pressure line connected to the annular chamber in communicating fashion and via which the annular chamber can be connected in communicating fashion to a low-pressure space of the rotating electrical machine, which space, with respect to a cooling fluid flow which can be generated by means of a shaft fan arranged on a rotor of the rotating electrical machine, is arranged upstream from the shaft fan.

According to the invention, a cooling fluid which flows through the at least one radially extending cooling duct of the axial end region is sucked selectively radially outward from the inside via the low-pressure line sealed with respect to the environment, which line is connected in communicating fashion to the low-pressure space of the rotating electrical machine, which space, with respect to a cooling fluid flow which can be generated by means of the shaft fan arranged on a rotor of the rotating electrical machine, is arranged upstream from the shaft fan. As a result, the axial end region of the stator is cooled, at least in places, to a greater extent than the remainder of the stator.

Owing to the intensified cooling of the axial end region, the upper output limit of the underexcited output range in the output graph of the rotating electrical machine can be extended and the underexcited output range consequently widened. This allows the rotating electrical machine and a power plant equipped therewith to have a wider range of use. In particular, a power plant can be operated effectively in a grid environment which is dominated by the high feeding-in of renewable energy because a required capacitive reactive power can be made available as a result of the cooling according to the invention of the stator and the accompanying widening of the underexcited output range in the output graph of the rotating electrical machine.

A corresponding widening of the underexcited output range in the output graph of a rotating electrical machine could conventionally be implemented only by relaminating an axial end region of a stator, formed as a sheet stack with laminated sheets, of the rotating electrical machine. However, this cannot be performed, for example, in the case of generators with a stator manufactured using complete impregnation technology. In the case of such generators, it is only possible to replace the whole wound stator sheet stack with a stator sheet stack with modified end zones in order to obtain a widening of the underexcited output range in the output graph of the generator.

During operation of the rotating electrical machine in its underexcited output range, the greatest heat occurs in the axial end regions of the stator which can be designed a plate stack. Such an axial end region can have a descending series of steps radially inward. Within the scope of the invention, both axial end regions of the stator can also be cooled correspondingly in each case with an independent arrangement according to the invention.

The annular chamber which can be arranged radially on the outer circumference of at least one portion, having at least one radially extending cooling duct, of the axial end region can be made from metal or another temperature-resistant material. Alternatively, the annular chamber can be made from a composite material, as a result of which electrical decoupling of the plate stack and other components of the rotating electrical machine, for example a partition wall, can be achieved. Grounding of the annular chamber should be ensured in any case. The annular chamber can have a C-shaped or U-shaped design in cross-section. The annular chamber can also be designed and arranged on the axial end region in such a way that it can be arranged radially on the outer circumference of a portion of the axial end region with two or more radially extending cooling ducts. The annular chamber is designed to be partially or completely open radially inward in the direction of the axial end region and can consequently be connected in communicating fashion to the at least one radial cooling duct. The annular chamber is sealed with respect to the axial end region so that, by means of the annular chamber, only cooling fluid which flows through the at least one cooling duct is sucked out, and no cooling fluid situated in the rest of the surrounding area of the annular chamber, which leaves the stator through cooling ducts which do not open into the annular chamber and extend radially. This would significantly reduce the efficiency of the cooling according to the invention. The arrangement can also have two or more annular chambers which can be arranged axially adjacent to each other.

The low-pressure line connected in communicating fashion to the annular chamber can be made from metal or another temperature-resistant material. The low-pressure line can be designed so that it is rigid or flexible to a predetermined extent. The arrangement can also have two or more corresponding high-pressure lines.

The low-pressure space of the rotating electrical machine which, with respect to the cooling fluid flow which can be generated by means of the shaft fan arranged on the rotor of the rotating electrical machine, is arranged upstream from the shaft fan is conventionally present for cooling a rotating electrical machine. As a result of operation of the shaft fan when the rotor is rotating, a static reduced pressure is generated in the low-pressure space which is used for sucking out, according to the invention, cooling fluid via the at least one annular chamber and the at least one low-pressure line. There is thus no need for any further components, which would have to be mounted on the rotating electrical machine, in order to generate the cooling according to the invention.

At least one fan, by means of which a fluid flow in the low-pressure line can be intensified, is advantageously arranged in the low-pressure line. The conveying capacity can be increased and the fluid flow in the low-pressure line intensified as a result of the insertion of the in particular controllable fan, which more significantly increases the cooling effect of the arrangement. As a result, the underexcited output range in the output graph of the rotating electrical machine can be widened more, which further increases the usability of the rotating electrical machine. The fan can be controlled as a function of the respective cooling need or be operated constantly. Two or more corresponding fans can also be arranged in the low-pressure line.

The low-pressure line is advantageously guided axially through radially extending partition walls of a high-pressure space containing a stator winding head of the rotating electrical machine, which space is arranged downstream from the shaft fan with respect to the cooling fluid flow which can be generated by means of the shaft fan. The high-pressure space can be separated by one of these partition walls from the low-pressure space of the rotating electrical machine. The further partition wall can be arranged radially on the outer circumference of the axial end region of the stator. As a result of the low-pressure line being guided through the partition walls, the low-pressure line is held in its desired position without any further components being needed for this purpose which would need to be mounted on the rotating electrical machine.

The rotating electrical machine according to the invention, in particular a generator, comprises:—a stator which is designed as a plate stack with radially extending cooling ducts;—a rotor on which at least one shaft fan is arranged outside the stator;—at least one low-pressure space which, with respect to a cooling fluid flow which can be generated by means of the shaft fan, is arranged upstream from the shaft fan;—at least one high-pressure space which contains a stator winding head and which, with respect to the cooling fluid flow which can be generated by means of the shaft fan, is arranged downstream from the shaft fan; and—at least one arrangement according to one of the preceding embodiments or any combination thereof.

The advantages mentioned above with respect to the arrangement are associated correspondingly with the rotating electrical machine. The rotating electrical machine can be designed as a generator, in particular a turbine generator. Two or more shaft fans, which work in suction or blower mode, can also be arranged on the rotor. The rotating electrical machine can have a separate low-pressure space for each axial end region of the stator. The rotating electrical machine can additionally have a separate high-pressure space for each axial end region of the stator. The rotating electrical machine can have at least one separate arrangement for each axial end region of the stator.

According to the method according to the invention for cooling at least one axial end region of a stator of a rotating electrical machine, in particular a generator, a cooling fluid which flows through at least one radially extending cooling duct of the axial end region is sucked selectively via a low-pressure line unit sealed with respect to the environment, which line unit is connected in communicating fashion to a low-pressure space of the rotating electrical machine, which space, with respect to a cooling fluid flow which can be generated by means of a shaft fan arranged on a rotor of the rotating electrical machine, is arranged upstream from the shaft fan.

The advantages mentioned above with respect to the arrangement are associated correspondingly with the method. Both axial end regions of the stator can also be cooled correspondingly. The low-pressure line unit can be formed by at least one annular chamber and at least one low-pressure line connected in communicating fashion to the annular chamber.

A fluid flow in the low-pressure line is advantageously intensified by means of at least one fan arranged in the low-pressure line. The advantages mentioned above with respect to the corresponding embodiment of the arrangement are associated correspondingly with this embodiment.

### BRIEF DESCRIPTION OF THE DRAWINGS

Anembodiment of the rotating electrical machine according to the invention is explained below with the aid of the attached schematic drawings, in which:

FIG. 1 shows a view of a portion of an exemplary embodiment for a rotating electrical machine according to the invention.

### DETAILED DESCRIPTION OF INVENTION

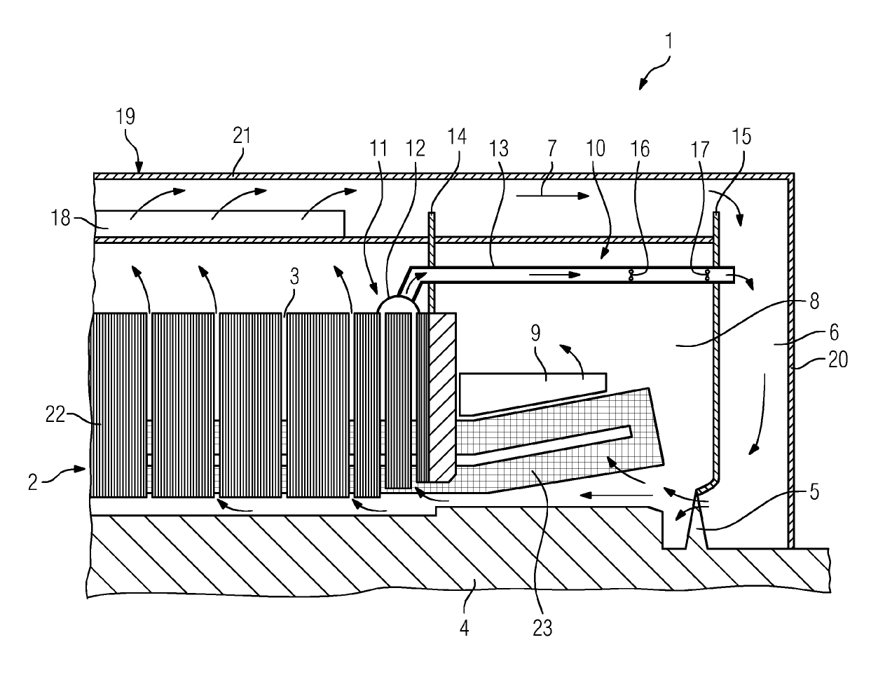

FIG. 1 shows a view of a portion of an exemplary embodiment for a rotating electrical machine 1 according to the invention in the form of a generator.

The rotating electrical machine 1 comprises a stator 2, which is designed as a plate stack with radially extending cooling ducts 3. The rotating electrical machine 1 furthermore comprises a rotor 4 on which at least one shaft fan 5 is arranged outside the stator 2.

The rotating electrical machine 1 additionally comprises at least one low-pressure space 6 which, with respect to a cooling fluid flow which can be generated by means of the shaft fan 5 and which is indicated by the arrows 7, is arranged upstream from the shaft fan 5. The rotating electrical machine 1 also comprises at least one high-pressure space 8 which contains a stator winding head 9 and which, with respect to the cooling fluid flow which can be generated by means of the shaft fan 5, is arranged downstream from the shaft fan 5.

The rotating electrical machine 1 moreover comprises at least one arrangement 10 for cooling the axial end region 11 shown of the stator 2 of the rotating electrical machine 1.

The arrangement 10 comprises an annular chamber 12 which can be arranged radially on the outer circumference of a portion, having two radially extending cooling ducts 3, of the axial end region 11. The annular chamber 12 is designed to be at least partially open radially inward in the direction of the axial end region 11 and as a result is connected in communicating fashion to the two radially extending cooling ducts 3. The annular chamber 12 is sealed with respect to the axial end region 11.

The arrangement 10 furthermore comprises at least one low-pressure line 13, connected in communicating fashion to the annular chamber 12 and via which the annular chamber 12 is connected in communicating fashion to the low-pressure space 6 of the rotating electrical machine 1. The low-pressure line 13 is guided axially through radially extending partition walls 14 and 15 of the high-pressure space 8. Two drivable fans 16 and 17, by means of which a fluid flow in the low-pressure line 13 can be intensified, are arranged in the low-pressure line 13. The fans 16 and 17 are, however, required only when the static pressure drop formed is insufficient to cause a corresponding cooling capacity. Together with the low-pressure line 13, the annular chamber 12 forms a low-pressure line unit.

With respect to the flow direction of the cooling fluid, indicated by the arrows 7, a cooler 18, by means of which the cooling fluid heated in the stator 2 and rotor 4 can be recooled so that it can be used again for cooling, is arranged downstream from the stator.

The rotating electrical machine 1 comprises a housing 19 which surrounds the stator 2 and an active part of the rotor 4. The housing 19 comprises end walls 20 and outer walls 21 arranged radially outward with respect to the stator 2.

The stator 2 comprises a support unit 23 on which stator components 22 and the stator winding head 9 are fastened.

Although the invention has been illustrated and described in detail by the preferred exemplary embodiment, the invention is not limited by the example disclosed and other variants can be derived by a person skilled in the art without going beyond the scope of the invention.

1. An arrangement for cooling at least one axial end region of a stator of a rotating electrical machine comprising:
at least one annular chamber which is arrangeable radially on the outer circumference of at least one portion, having at least one radially extending cooling duct, of the axial end region, and which has-is designed to be at least partially open radially inward in the direction of the axial end region and as a result is connectable in communicating fashion to the radial cooling duct, and which is sealed with respect to the axial end region; and
at least one low-pressure line connected to the annular chamber in communicating fashion and via which the annular chamber is connectable in communicating fashion to a low-pressure space of the rotating electrical machine, which space, with respect to a cooling fluid flow which is generated by a shaft fan arranged on a rotor of the rotating electrical machine, is arranged upstream from the shaft fan.

2. The arrangement as claimed in claim 1,
wherein at least one fan, by which a fluid flow in the low-pressure line is intensified, is arranged in the low-pressure line.

3. The arrangement as claimed in claim 1,
wherein the low-pressure line is guided axially through radially extending partition walls of a high-pressure space containing a stator winding head of the rotating electrical machine, which space is arranged downstream from the shaft fan with respect to the cooling fluid flow which is generated by the shaft fan.

4. A rotating electrical machine, comprising:
a stator which is designed as a plate stack with radially extending cooling ducts;
a rotor on which at least one shaft fan is arranged outside the stator;
at least one low-pressure space which, with respect to a cooling fluid flow which is generated by the shaft fan, is arranged upstream from the shaft fan;
at least one high-pressure space which contains a stator winding head and which, with respect to the cooling fluid flow which is generated by the shaft fan, is arranged downstream from the shaft fan; and
at least one arrangement as claimed in claim 1.

5. A method for cooling at least one axial end region of the stator of a rotating electrical machine, the method comprising:
selectively sucking a cooling fluid which flows through at least one radially extending cooling duct of the axial end region via a low-pressure line unit sealed with respect to the environment,
wherein the line unit is connected in communicating fashion to a low-pressure space of the rotating electrical machine,
wherein the space, with respect to a cooling fluid flow which is generated by a shaft fan arranged on a rotor of the rotating electrical machine, is arranged upstream from the shaft fan.

6. The method as claimed in claim 5,
wherein a fluid flow in the low-pressure line unit is intensified at least one fan arranged in the low-pressure line unit.

7. The arrangement as claimed in claim 1,
wherein the rotating electrical machine comprises a generator.

8. The method as claimed in claim 5,
wherein the rotating electrical machine comprises a generator.
